(19) United States
(12) Patent Application Publication
(10) Pub. No.: US 2012/0179280 A1
(43) Pub. Date: Jul. 12, 2012

(54) Pedestrian Warning System for an Electric or Hybrid Vehicle

(75) Inventor: Ian Faye, Stuttgart (DE)

(73) Assignee: Robert Bosch GmbH, Stuttgart (DE)

(21) Appl. No.: 13/386,419

(22) PCT Filed: Jul. 7, 2010
(86) PCT No.: PCT/EP10/59729

§ 371 Date: Mar. 24, 2012

(30) Foreign Application Priority Data
Jul. 22, 2009 (DE) 10 2009 027 911.3

(51) Int. Cl. G06F 17/00

(52) U.S. Cl. 700/94

(57) ABSTRACT

A system is disclosed for warning at least one person in the vicinity of a motor vehicle, particularly an electric vehicle or a hybrid vehicle. The system includes at least one generator for generating an audio signal, a device for switching the generator on and off and/or for controlling the volume of the audio signal. At least one person and/or an object in the vicinity of the motor vehicle can be captured by a person-detecting system, and the at least one generator can be switched on and off and/or the volume of the audio signal can be controlled by the device as a function of the at least one person and/or the object.

The present invention relates to a system for warning at least one person in surroundings of a motor vehicle in accordance with the preamble of claim 1 and to a method for warning at least one person in surroundings of a motor vehicle in accordance with the preamble of claim 9.

### PRIOR ART

For reasons of environmental protection and to save expensive fossil fuels, motor vehicles in the form of electric vehicles or in the form of hybrid vehicles are increasingly being used. Electric vehicles have only an electric motor for driving the vehicle and hybrid vehicles have both an internal combustion engine and an electric motor for driving the hybrid vehicle. Internal combustion engines, particularly reciprocating piston internal combustion engines, in motor vehicles have characteristic noise generation. Noise emission from the internal combustion engine can warn persons in surroundings of the motor vehicle, e.g. pedestrians or cyclists, as road users, about the motor vehicle and therefore represents a safety aspect. Electric vehicles and hybrid vehicles have no such noise emission when the vehicle is driven by the electric motor, which means that passers-by and road users are not able to be audibly warned about the vehicle. This can increase the risk of accident for the road users.

DE 197 01 801 C2 shows an apparatus for the imitative production of engine and driving noises in vehicles, particularly in motor-driven motor vehicles, with a measuring apparatus which can be activated by the vehicle speed, with a noise generator which is operatively connected to the measuring apparatus, with at least one noise radiation apparatus which is connected to the noise generator and with a noise carrier which is operatively connected to the noise generator.

DE 10 2007 003 201 A1 shows a device for producing audio signals for electrically operated vehicles or for hybrid vehicles. The audio signal, e.g. a tone, a sound or a noise, is produced by an audio generator and is used to warn passers-by, for example, about the approaching electrically operated vehicle or hybrid vehicle. A loudspeaker as an audio generator can be switched on only when the vehicle exceeds a particular speed.

DE 195 40 768 A1 discloses a signal tone apparatus for motor vehicles and electric vehicles, wherein when the motor vehicle is traveling forward an uninterrupted or intermittent signal tone can be output which is significantly quieter than a horn sound.

### DISCLOSURE OF THE INVENTION

Advantages of the Invention

A system according to the invention for warning at least one person in surroundings of a motor vehicle, particularly an electric vehicle or a hybrid vehicle, comprising at least one generator for producing an audio signal, a device for switching on and off the generator and/or for controlling the volume of the audio signal, wherein a person recognition system can sense at least one person and/or an object in the surroundings of the motor vehicle and the device can take the at least one person and/or the object as a basis for switching on or off the at least one generator and/or for controlling the volume of the audio signal.

A person in the surroundings of the motor vehicle, e.g. a pedestrian or a cyclist, as a road user for the motor vehicle, is thereby warned about the motor vehicle by the audio signal. In particular, the generator produces the audio signal only when there is at least one person in the close surroundings of the motor vehicle, e.g. a person at a distance of less than 100, 50, 30, 20, 10 or 5 m away from the motor vehicle. Hence, the audio signal for warning the person is produced only when it is actually necessary. Hence, if there is no person in the close surroundings of the motor vehicle, the motor vehicle moves or travels with particularly little noise.

In particular, the data captured by the person recognition system and a computation unit can be used to ascertain a hazard potential which the motor vehicle presents to the at least one person, and the hazard potential can be taken as a basis for using the device to switch on or off the at least one generator and/or to control the volume of the audio signal. The computation unit evaluates the data captured by the person recognition system, calculates the hazard potential or the magnitude of the hazard potential therefrom, and the hazard potential is taken as a basis for switching on or off the device and/or for controlling the volume of the audio signal. By way of example, the audio signal is therefore controlled not only on the basis of the speed of the motor vehicle but also on the basis of the hazard from the motor vehicle which the motor vehicle presents to the at least one person in the surroundings of the motor vehicle.

In a further refinement, the volume of the audio signal can be controlled on the basis of the magnitude of the hazard potential.

The greater the hazard potential, the higher preferably the volume of the audio signal produced by the at least one generator, and vice versa. When the motor vehicle presents a great hazard potential to the person, an audio signal with a high volume is therefore produced, and vice versa, so that the person is warned as appropriate.

Preferably, the magnitude of the hazard potential can be ascertained on the basis of the distance and/or an alteration in the distance between the motor vehicle and the at least one person and/or on the basis of the distance between a probable path of the motor vehicle and the at least one person.

In a further refinement, the magnitude of the hazard potential can be ascertained on the basis of the distance between the motor vehicle and a probable path of the at least one person and/or on the basis of the distance between the probable path of the motor vehicle and the probable path of the at least one person. In particular, the distance and/or the alteration in the distance between the person and the motor vehicle are a parameter for the magnitude of the hazard potential. In this case, not only the distance or the alteration in the distance but also the speed of the motor vehicle, the direction of the motor vehicle and/or also the speed of the at least one person and/or the direction of the at least one person are taken into account for the purpose of ascertaining the magnitude of the hazard potential. The shorter the distance, the greater the hazard potential, and vice versa. The greater the alteration in the distance per unit time, the greater the hazard potential when the distance is shortened on the basis of the alteration, and vice versa. In addition, it is also possible to sense the surroundings of the motor vehicle by sensing an opportunity for the motor vehicle to swerve in order to avoid a collision and by ascertaining the hazard potential to be greater the smaller the opportunity for swerving, and vice versa.

In one variant, the audio signal is a tone, a sound, a noise, particularly an engine noise, or a warning signal.

Expediently, the person recognition system is a video system and/or a radar and/or an infrared camera. In this case, the person recognition system can sense the distance between the motor vehicle and the at least one person and/or the object and/or an alteration in the distance between the motor vehicle and the at least one person and/or the object and/or the speed of the at least one person and/or the object and/or the direction of movement of the at least one person and/or the object.

In a further embodiment, the at least one generator is a loudspeaker and/or a bell.

In a further refinement, the system comprises at least two generators. By way of example, a plurality of loudspeakers are therefore fitted on the motor vehicle at different locations. Preferably, these loudspeakers are switched on or off, and/or the volume of the loudspeakers is controlled, specifically on the basis of the position of the at least one person relative to the motor vehicle. If a person in the direction of travel of the motor vehicle is located to the right thereof, for example, a loudspeaker on the right-hand side of the motor vehicle is operated, or operated particularly loudly, and a loudspeaker on the left-hand side of the motor vehicle is not operated, or is operated quietly, for example.

In a further refinement, an error or a fault in the system can be sensed and an error prompts the production of a prescribed audio signal. Hence, a warning is also possible in the event of an error or a fault.

A method according to the invention for warning at least one person in surroundings of a motor vehicle, particularly an electric vehicle or a hybrid vehicle, having the following steps: an audio signal is produced, the volume and/or the presence of the audio signal is controlled, wherein the hazard potential from the traveling motor vehicle for the at least one person in surroundings of the motor vehicle is ascertained and the hazard potential is taken as a basis for controlling the audio signal.

In particular, a person recognition system is used to sense the at least one person.

In a further refinement, the magnitude of the hazard potential is ascertained on the basis of the distance and/or an alteration in the distance between the motor vehicle and the at least one person and/or the object and/or on the basis of the distance between a probable path of the motor vehicle and the at least one person and/or the object and/or on the basis of the distance between a probable path of the motor vehicle and a probable path of the at least one person and/or the object.

In an enhancing variant, the surroundings of the motor vehicle, e.g. a kindergarten, a school or a hospital, are sensed, particularly using GPS and stored maps, and the surroundings are taken as a basis for ascertaining the hazard potential. The surroundings of the motor vehicle are therefore also taken into account for ascertaining the hazard potential. If the surroundings are surroundings which result in a particular hazard being assumed, e.g. a school in proximity to a motor vehicle, the hazard potential is ranked higher even when the distance between the person and the motor vehicle is the same than if the motor vehicle is not in the surroundings of the school.

The greater the hazard potential, the higher preferably the volume of the audio signal produced by the at least one generator, and vice versa.

In a further refinement, from a prescribed first magnitude of the hazard potential upward the at least one generator is switched on and/or a drop below the prescribed first magnitude of the hazard potential prompts the at least one generator to be switched off.

In particular, from a prescribed second magnitude of the hazard potential upward the audio signal is changed over from an engine noise to a warning signal and/or a drop below the prescribed second magnitude of the hazard potential prompts the audio signal to be changed over from the warning signal to an engine noise.

Preferably, the second magnitude of the hazard potential is greater than the first magnitude of the hazard potential.

### BRIEF DESCRIPTION OF THE DRAWINGS

An exemplary embodiment of the invention is described in more detail below with reference to the appended drawings, in which:

FIG. 1 shows a block diagram of a system for warning at least one person in surroundings of a motor vehicle, and

FIG. 2 shows a side view of a motor vehicle and the person.

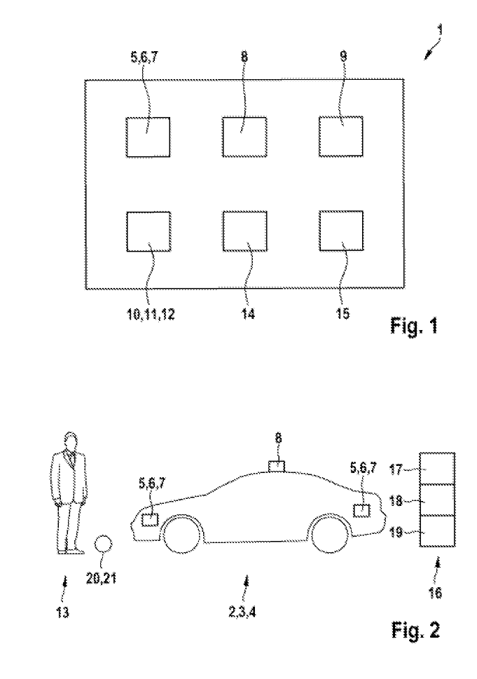

FIG. 1 depicts a system 1 for warning at least one person 13 in surroundings 16 of a motor vehicle 2. The motor vehicle 2, particularly an electric vehicle 3 or a hybrid vehicle 4, is provided with an electric motor for driving the motor vehicle 2. When the motor vehicle 2 is driven exclusively by means of the electric motor (not shown), the motor vehicle 2 moves or travels with very little noise generation. In order to be able to warn road users for the motor vehicle 2, e.g. pedestrians or cyclists, the system 1 has a generator 5 for producing an audio signal.

By way of example, the generator 5 for producing the audio signal is a loudspeaker 6 or a bell 7. The type of the audio signal, e.g. an engine noise or a warning signal, is stored on a memory, e.g. a memory chip, a microchip or on a USB stick. When a USB stick is used, the driver of the motor vehicle can therefore also store audio signals which he desires on the USB stick and can reproduce them as a warning signal through the loudspeaker 6. Using a computation unit 9 and an input unit—not shown—the user of the motor vehicle 2 can also choose between different types of audio signals for warning the at least one person 13. Transmission cables—not shown—are used by the computation unit 9 to drive the loudspeaker 6 as appropriate. In this case, there are preferably a plurality of loudspeakers 6 on the motor vehicle 2. By way of example, there is a respective loudspeaker 6 at the front right, the front left, the rear left and the rear right for the purpose of specifically warning persons 13 in the surroundings 16 of the motor vehicle 2.

A person recognition system 8 recognizes or senses at least one person 13 and/or an object 20, e.g. a ball 21, in the surroundings 16 of the motor vehicle 2. By way of example, in the event of a ball 21 rolling onto a road, persons 13, particularly children, running onto the road after the ball 21 are inferred. The person recognition system 8, e.g. a video system 10, a radar 11 and/or an infrared camera 12, can sense the distance between the at least one person 13 and/or the object 20 and the motor vehicle 2 and/or the alteration in the distance between the at least one person 13 and/or the object 20 and the motor vehicle 2 in this case. In addition, the person recognition system 8 also senses the speed and the direction of movement of the at least one person 13. The motor vehicle 2 is furthermore provided with an apparatus 14 for sensing the vehicle speed and the direction of movement of the motor vehicle 2. Hence, the computation unit 9 can calculate both the probable path of the motor vehicle 2 and the probable path of the at least one person 13. From the data captured by the person recognition system 8 and the apparatus 14 for sensing the speed and the direction of movement of the motor vehicle 2, the computation unit 9 calculates the magnitude of the hazard potential of the motor vehicle 2 for the at least one person 13.

From a prescribed first magnitude of the hazard potential upward, the generator 5 is switched on by a device 15 for switching on and off the generator and/or for controlling the volume of the audio signal, and an engine noise is produced as an audio signal. The greater the hazard potential becomes, i.e. essentially the shorter the distance between the motor vehicle 2 and the at least one person 13 becomes, the louder the volume of the audio signal becomes. If the magnitude of the hazard potential exceeds a second prescribed magnitude, the audio signal is changed over from the engine noise to a warning signal. In this case, the warning signal is significantly louder than the engine noise and is also perceived more consciously by the at least one person 13 on account of the type of the noise. If the distance between the motor vehicle 2 and the at least one person 13 becomes greater again, the warning signal is automatically changed over to the engine noise as an audio signal again. If the distance between the at least one person and the motor vehicle 2 becomes even greater, so that the magnitude of the hazard potential drops below the first magnitude, the generator 5 is switched off completely, as a result of which the generator 2 no longer produces a warning signal as an audio signal for the at least one person 13. Hence, the audio signal for warning the person 13 as a road user is produced only when an audible warning signal is actually necessary. Advantageously, the electric vehicle 2 can therefore move with particularly low noise without the audio signal if there is a very low hazard potential or if a road user is not present in the close surroundings of the motor vehicle 2.

Besides the distance between the person 13 and the motor vehicle 2, it is also possible to take account of the type of the surroundings 16 of the motor vehicle 2 for the purpose of ascertaining the magnitude of the hazard potential. If the motor vehicle 2 is equipped with GPS, for example, and if a building with a particular hazard situation, e.g. a school 18, a hospital 19 or a kindergarten 17, is within the close surroundings 16 of the motor vehicle 2, the magnitude of the hazard potential is ranked higher when the distance between the person 13 and the motor vehicle 2 is the same than if there are no such surroundings 16 in proximity of the motor vehicle 2. Furthermore, The distance between the specific surroundings 16 and the motor vehicle 2 can also be taken into account. The shorter the distance between the motor vehicle 2 and the specific surroundings 16, the greater the additional magnitude of the hazard potential that is ascertained on the basis of the presence of the specific surroundings 16 of the motor vehicle 2, and vice versa.

When considered overall, the system 1 according to the invention for warning the person 13 in the surroundings of the motor vehicle 2 has considerable advantages associated with it. The volume of the audio signal is matched to the hazard potential of the motor vehicle 2 for the person 13, which means that it is possible to audibly warn the person 13 about the motor vehicle 2 in a particularly effective and safe manner. In addition, the audio signal is produced only when there is a hazard for the person 13, which means that the electric vehicle 3 or the hybrid vehicle 4 can move particularly quietly and hence in an environmentally friendly manner when there is no or only a low hazard potential.

1. A system for warning at least one person in surroundings of a motor vehicle, comprising
at least one generator configured to produce an audio signal,
a device configured to switch on and off the generator and/or control the volume of the audio signal, and
a person recognition system configured to sense at least one person and/or an object in the surroundings of the motor vehicle, and
wherein the device switches on or off the at least one generator and/or controls the volume of the audio signal based on the person recognition system sensing the at least one person and/or the object.

2. The system as claimed in claim 1, further comprising a computational unit, wherein:
data captured by the person recognition system and the computation unit is utilized to ascertain a hazard potential which the motor vehicle presents to the at least one person, and
the device switches on or off the at least one generator and/or controls the volume of the audio signal based on the hazard potential.

3. The system as claimed in claim 2, wherein the device controls the volume of the audio signal based on the magnitude of the hazard potential.

4. The system as claimed in claim 3, wherein the greater the hazard potential, the higher the volume of the audio signal produced by the at least one generator, and vice versa.

5. The system as claimed in claim 2, wherein:
the magnitude of the hazard potential can be ascertained on the basis of the distance and/or an alteration in the distance between the motor vehicle and the at least one person and/or on the basis of the distance between a probable path of the motor vehicle and the at least one person.

6. The system as claimed in claim 1, wherein the audio signal is a tone, a sound, an engine noise, or a warning signal.

7. The system as claimed in claim 1, wherein the person recognition system is a video system and/or a radar and/or an infrared camera.

8. The system as claimed in claim 1, wherein the at least one generator is a loudspeaker and/or a bell.

9. A method for warning at least one person in surroundings of a motor vehicle, comprising:
producing an audio signal,
ascertaining a hazard potential from the traveling motor vehicle for the at least one person in the surroundings of the motor vehicle, and
controlling the volume and/or the presence of the audio signal based on the hazard potential.

10. The method as claimed in claim 9, further comprising utilizing a person recognition system to sense the at least one person.

11. The method as claimed in claim 10, wherein the magnitude of the hazard potential is ascertained on the basis of the distance and/or an alteration in the distance between the motor vehicle and the at least one person and/or on the basis of the distance between a probable path of the motor vehicle and the at least one person and/or on the basis of the distance between the probable path of the motor vehicle and a probable path of the at least one person.

12. The method as claimed in claim 9, wherein:
the surroundings of the motor vehicle are sensed using GPS and stored maps, and
the surroundings are taken as a basis for ascertaining the hazard potential.

13. The method as claimed in claim 9, wherein the greater the hazard potential, the higher the volume of the audio signal produced by the at least one generator, and vice versa.

14. The method as claimed in claim 9, wherein from a prescribed first magnitude of the hazard potential upward the at least one generator is switched on and/or a drop below the prescribed first magnitude of the hazard potential prompts the at least one generator to be switched off.

15. The method as claimed in claim 9, wherein from a prescribed second magnitude of the hazard potential upward the audio signal is changed over from an engine noise to a warning signal and/or a drop below the prescribed second magnitude of the hazard potential prompts the audio signal to be changed over from the warning signal to an engine noise.
